(19) United States
(12) Patent Application Publication
(10) Pub. No.: US 2026/0365810 A1
(43) Pub. Date: Nov. 19, 2026

(54) DECHLORINATION OF PVC UNDER MILD CONDITIONS FOR DUAL VALORIZATION OF CARBON AND CHLORINE

(71) Applicant: Massachusetts Institute of Technology, Cambridge, MA (US)

(72) Inventors: Yang Shao-Horn, Cambridge, MA (US); Yuriy Roman, Cambridge, MA (US); Xiao Wang, Saskatoon (CA); Zachary Westman, Boston, MA (US); Griffin Drake, Belmont, MA (US); Marcos Garcia Farpon, Boston, MA (US)

(21) Appl. No.: 19/680,309

(22) Filed: May 18, 2026

Related U.S. Application Data
(60) Provisional application No. 63/806,972, filed on May 16, 2025.

(51) Int. Cl. C08J 11/04; B01J 27/08; C08K 3/28; C08K 5/05

(52) U.S. Cl. CPC C08J 11/04; B01J 27/08; C08K 3/28; C08K 5/05; C08J 2327/06

(57) ABSTRACT

Disclosed are methods of dechlorinating polymers.

### RELATED APPLICATION

This application claims the benefit of priority to U.S. Provisional Patent Application No. 63/806,972, filed May 16, 2025.

### STATEMENT OF GOVERNMENT SUPPORT

This invention was made with government support under DE-AC36-08GO28308 awarded by the Department of Energy. The government has certain rights in the invention.

### BACKGROUND

Polyvinyl chloride (PVC) is a high-volume chlorinated thermoplastic that presents significant challenges for chemical recycling due to its high chlorine content and thermal instability. Conventional dechlorination strategies rely on high-temperature processes (≥400 °C), often resulting in the release of corrosive hydrochloric acid (HCl), generation of polyaromatic char, and limited value recovery from either chlorine or carbon. Alternative methods using ionic liquids remain economically prohibitive at scale. Moreover, these approaches rarely provide access to functional, upcyclable polymer backbones. Therefore, there is an ongoing, unmet need for new methods of dechlorinating polymers.

### SUMMARY OF THE INVENTION

Disclosed herein are dechlorination methods that are performed at milder temperatures (e.g., as low as 150 °C) using ammonia (NH₃) gas and aliphatic alcohol solvents. In certain embodiments, the methods achieve quantitative dechlorination (~100%) of PVC while producing ammonium chloride (NH₄Cl) in yields exceeding 93 mol %, which is a valuable co-product with established fertilizer applications. Notably, the reaction pathway avoids the formation of polyaromatic char and instead results in a stable, soluble dechlorinated PVC (dPVC) polymer bearing alkene and ether functionalities.

### BRIEF DESCRIPTION OF THE DRAWINGS

FIG. 1 is a scheme showing (1) NH₃-mediated elimination to generate alkenes and NH₄Cl, (2) nucleophilic substitution of chloride by alcohols to generate ethers and NH₄Cl, and (3) addition of alcohols to alkenes to generate ethers.

FIG. 2A shows ¹H NMR spectra of soluble dPVC obtained from PVC dechlorination with NH₃ and 1-butanol. Reaction conditions: 221 mg PVC, 5 mL 1-butanol, 80 psig NH₃, 18 hours at 150 °C.

FIG. 2B shows an ¹H-¹³C HSQC NMR spectra of soluble dPVC obtained from PVC dechlorination with NH₃ and 1-butanol. Reaction conditions: 221 mg PVC, 5 mL 1-butanol, 80 psig NH₃, 18 hours at 150 °C. * Note that the nitrogen content is not quantified via NMR.

FIG. 2C shows ¹H-¹⁵N HMBC NMR spectra for different portions of soluble dPVC obtained after liquid-liquid extraction using ethyl acetate and water mixture. Reaction conditions: PVC powders, 221 mg; 1-butanol, 5 mL; 15N-enriched NH₃, 160 psig; temperature, 170 °C for 18 h.

FIG. 3A shows the dechlorination efficiency, as calculated by ¹H NMR of soluble dPVC, ¹H NMR of aq. NH₄Cl and IC. Reaction conditions: 221 mg PVC, 5 mL solvent, 80 psig NH₃, 18 hours at 150 °C.

FIG. 3B shows the soluble dPVC chemical composition, as calculated by ¹H NMR. Reaction conditions: 221 mg PVC, 5 mL solvent, 80 psig NH₃, 18 hours at 150 °C.

FIG. 3C shows the ether efficiency/selectivity, as calculated by ¹H NMR, for PVC upcycling with NH₃ gas and THF or C₃-C₇ alcohols as solvents. Reaction conditions: 221 mg PVC, 5 mL solvent, 80 psig NH₃, 18 hours at 150 °C.

FIG. 4A shows NH₄Cl yield (as measured by ¹H NMR of aq. NH₄Cl and IC) and DE (as measured by ¹H NMR of the soluble dPVC), for PVC upcycling with 1-3×80 psig NH₃ gas and 1-pentanol as the solvent. Reaction conditions: 221 mg PVC, 5 mL alcohol, 1-3×80 psig NH₃ (NH₃:Cl (mol:mol)=1.5-4.5:1), 18 hours at 150 °C.

FIG. 4B shows NH₄Cl yield (as measured by ¹H NMR of aq. NH₄Cl and IC) and DE (as measured by ¹H NMR of the soluble dPVC), for PVC upcycling with 1-3×80 psig NH₃ gas and 1-butanol as the solvent. Reaction conditions: 221 mg PVC, 5 mL alcohol, 1-3×80 psig NH₃ (NH₃:Cl (mol:mol)=1.5-4.5:1), 18 hours at 150 °C.

FIG. 5A shows DE, as calculated by ¹H NMR of soluble dPVC, for PVC upcycling with NH₃ gas and 1-butanol from 150-170 °C. Reaction conditions: 221 mg PVC, 5 mL 1-butanol, 2×80 psig NH₃.

FIG. 5B shows ORE, as calculated by ¹H NMR of soluble dPVC, for PVC upcycling with NH₃ gas and 1-butanol from 150-170 °C. Reaction conditions: 221 mg PVC, 5 mL 1-butanol, 2×80 psig NH₃.

FIG. 5C shows soluble dPVC chemical composition, as calculated by ¹H NMR of soluble dPVC, for PVC upcycling with NH₃ gas and 1-butanol at 160 °C. Reaction conditions: 221 mg PVC, 5 mL 1-butanol, 2×80 psig NH₃.

FIG. 6A shows NH₄Cl yields (as measured by ¹H NMR of aq. NH₄Cl and IC) for PVC upcycling with NH₃ and 1-pentanol with increasing PVC loadings Reaction conditions: (a) 83-221 mg PVC, 5 mL 1-pentanol, 2×80 psig NH₃, 150 °C, 18 hours.

FIG. 6B shows NH₄Cl yields (as measured by ¹H NMR of aq. NH₄Cl and IC) for PVC upcycling with NH₃ and 1-pentanol with increasing 1-pentanol volume. Reaction conditions: 221 mg PVC, 2.5-10 mL 1-pentanol, 1×80 psig NH₃, 150 °C, 18 hours.

FIG. 7A shows NH₄Cl yield (as measured by ¹H NMR of aq. NH₄Cl and IC) and DE (as measured by ¹H NMR of the soluble dPVC). Reaction conditions: 221 mg PVC, 5 mL solvent, 2×80 psig NH₃, 150 °C, 18 hours.

FIG. 7B shows ORE/ORS (as measured by ¹H NMR of the soluble dPVC) and final (hot) reaction pressure for PVC upcycling with NH₃ and solvent mixtures of THF and 1-butanol. Reaction conditions: 221 mg PVC, 5 mL solvent, 2×80 psig NH₃, 150 °C, 18 hours.

FIG. 8 shows ¹H NMR spectra of PVC (top) and dPVC from a reaction with 100% DE (bottom). Signals from —CHCl— moieties totally disappeared from the dPVC spectrum, indicating full dechlorination. Reaction conditions: 221 mg PVC, 5 mL 1-butanol, 2×80 psig NH₃, 150 °C, 48 hours.

FIG. 9 shows an overview of typical strategies for PVC waste treatment. Compared with pyrolysis and base-initiated dehydrochlorination, this strategy generates easily separable NH₄Cl salt and stabilized dPVC at milder conditions. X in the dPVC structure represents hydrogen or amine.

FIG. 10 shows proposed possible mechanisms including NH₃-initiated dehydrochlorination, ether substitution by alcohols, amine substitution (i.e., amination), and transfer hydrogenation. X in the dPVC structure represents hydrogen or amine.

FIG. 11A shows solvent screening for PVC dechlorination in NH₃. Reaction conditions: PVC powders, 221 mg; solvent, 5 mL; NH₃, 80 psig; temperature, 150 °C for 18 h. THF: tetrahydrofuran; CPME: cyclopentyl methyl ether; MCC: methyl cyclohexanecarboxylate; THFA: tetrahydrofurfuryl alcohol.

FIG. 11B shows a comparison of primary and secondary alcohols for PVC dechlorination in NH₃. Error bars represent standard deviations.

FIG. 12A shows a primary alcohol screening for PVC dechlorination at 150 °C. Reaction conditions: PVC powders, 221 mg; alcohol, 5 mL; NH₃, 80 psig; temperature, 150 °C for 18 h. Three different approaches to measure extent of dechlorination showed consistency. NH₄⁺ NMR, Cl⁻ IC, and dPVCₛₒₗ NMR stand for ¹H NMR measuring NH₄⁺ concentration, IC measuring Cl⁻ concentration, and ¹H NMR measuring chlorine content in soluble dPVC, respectively.

FIG. 12B shows a secondary alcohol screening for PVC dechlorination at 150 °C. Reaction conditions: PVC powders, 221 mg; alcohol, 5 mL; NH₃, 80 psig; temperature, 150 °C for 18 h. Three different approaches to measure extent of dechlorination showed consistency. NH₄⁺ NMR, Cl⁻ IC, and dPVCₛₒₗ NMR stand for ¹H NMR measuring NH₄⁺ concentration, IC measuring Cl concentration, and ¹H NMR measuring chlorine content in soluble dPVC, respectively.

FIG. 13 is a graph showing a comparison of effect of primary and secondary alcohols on ether yield and selectivity during PVC dechlorination. Reaction conditions: PVC powders, 221 mg; alcohol, 5 mL; NH₃, 80 psig; temperature, 150 °C for 18 h.

FIG. 14 shows the temperature impact on dechlorination and insoluble dPVC formation for PVC dechlorination in 1-butanol, 1-pentanol, and 1-hexanol. Reaction conditions: PVC powders, 221 mg; alcohol, 5 mL; NH₃, 80 psig; temperature, 150-200 °C for 18 h.

FIG. 15A shows the influence of NH₃ filling pressure on PVC dechlorination in 1-butanol. PVC powders, 221 mg. Reaction conditions: PVC powders, 221 or 110 mg; 1-butanol, 5 mL; NH₃, 40-240 psig; temperature, 150 °C for 18 h. A lower PVC loading (i.e. 110 mg) allows investigation of lower NH₃ pressures.

FIG. 15B shows the influence of NH₃ filling pressure on PVC dechlorination in 1-butanol. PVC powders, 110 mg. Reaction conditions: PVC powders, 221 or 110 mg; 1-butanol, 5 mL; NH₃, 40-240 psig; temperature, 150 °C for 18 h. A lower PVC loading (i.e. 110 mg) allows investigation of lower NH₃ pressures.

FIG. 16A is a schematic of an NH₃ filling setup.

FIG. 16B shows a comparison of the conventional NH₃ purging process and the new filling setup. Reaction conditions: PVC powders, 221 mg; 1-butanol, 5 mL; temperature, 150 °C for 18 h. Unless otherwise noted, the conventional NH₃ purging process was used.

FIG. 17A shows the influence of NH₃ filling pressure on PVC dechlorination in ethanol. Reaction conditions: PVC powders, 221 mg; alcohol, 5 mL; NH₃, 80-320 psig; temperature, 150 °C for 18 h.

FIG. 17B shows the influence of NH₃ filling pressure on PVC dechlorination in 1-pentanol. Reaction conditions: PVC powders, 221 mg; alcohol, 5 mL; NH₃, 80-320 psig; temperature, 150 °C for 18 h.

FIG. 18 shows a reaction time series at different temperatures in 1-butanol. The inset shows that no CHCl peak exists in soluble dPVC after reaction. Reaction conditions: PVC powders, 221 mg; 1-butanol, 5 mL; NH₃, 160 psig; temperature, 150-170 °C for 1-48 h.

FIG. 19A shows the determination of apparent rate constants (−kₐₚₚ) using ln(1-NH₄Cl Yield)=−kₐₚₚt. Reaction conditions: PVC powders, 221 mg; 1-butanol, 5 mL; NH₃, 160 psig; temperature, 150-170 °C for 1-18 h.

FIG. 19B shows the determination of the apparent activation energy barrier for PVC dechlorination. Reaction conditions: PVC powders, 221 mg; 1-butanol, 5 mL; NH₃, 160 psig; temperature, 150-170 °C for 1-18 h.

FIG. 20A shows the characterization of soluble dPVC obtained in 1-butanol at different reaction time via ¹H NMR. Reaction conditions: PVC powders, 221 mg; 1-butanol, 5 mL; NH₃, 160 psig; temperature, 170 °C for 1-18 h.

FIG. 20B shows the characterization of soluble dPVC obtained in 1-butanol at different reaction time via ATR-FTIR. Reaction conditions: PVC powders, 221 mg; 1-butanol, 5 mL; NH₃, 160 psig; temperature, 170 °C for 1-18 h.

FIG. 21A shows the influence of alcohol concentration on EOD, ORY, and ORS. DEₛₒₗ represents dechlorination efficiency in soluble dPVC. Reaction conditions: PVC powders, 221 mg; solvent, 5 mL; NH₃, 160 psig; temperature, 150 °C for 18 h.

FIG. 21B shows the influence of alcohol concentration on CCY and CCS. Reaction conditions: PVC powders, 221 mg; solvent, 5 mL; NH₃, 160 psig; temperature, 150 °C for 18 h.

FIG. 22 shows the dechlorination of various PVC commodities. Reaction conditions: PVC commodities, 221 mg; 1-butanol, 5 mL; NH₃, 160 psig; temperature, 170 °C for 18 h.

FIG. 23A shows a system scale-up in a 25 mL reactor. NH₄Cl yield and normalized insoluble dPVC amount for different PVC loadings. Reaction conditions: PVC powders, 221, 500, and 1000 mg; 1-butanol, 5 mL; NH₃, 160, 240, and 320 psig; temperature, 170 °C for 18 h. *: temperature, 150 °C for 48 h.

FIG. 23B shows an experimentally obtained vs expected soluble dPVC for different PVC loadings. Reaction conditions: PVC powders, 221, 500, and 1000 mg; 1-butanol, 5 mL; NH₃, 160, 240, and 320 psig; temperature, 170 °C for 18 h. *: temperature, 150 °C for 48 h.

FIG. 24 shows the influence of HDPE, LDPE, and PP on PVC dechlorination. Reaction conditions: PVC powders, 221 mg; (HDPE, LDPE, or PP sheets, 221 mg) 1-butanol, 5 mL; NH₃, 160 psig; temperature, 170 °C for 18 h.

FIG. 25 shows the processing of a simulated chlorine-contaminated polyolefin waste stream. Reaction conditions: PVC powders, 240 mg; LDPE, HDPE, and PP sheets, 80 mg each; 1-butanol, 5 mL; NH₃, 160 psig; temperature, 170 °C for 18 h.

FIG. 26 shows NH₄Cl yield, ORS, and CCS for PVC dechlorination catalyzed by iodides. Reaction conditions: PVC powders, 221 mg; 1-butanol, 5 mL; NH₃, 80 psig; temperature, 150 °C for 4 h.

FIG. 27 is a ¹H NMR spectrum of a hydrogenated dPVC. Reaction conditions: PVC powders, 221 mg; 5 wt % Pt/C, 59 mg; 1-butanol, 5 mL; NH₃, 12.7 mmol; H₂, 4.2 mmol; temperature, 150 °C for 18 h.

FIG. 28 shows an ATR-FTIR spectrum of 5 wt % Pt/C before and after reaction. Reaction conditions: PVC powders, 221 mg; 5 wt % Pt/C, 118 mg; 1-butanol, 5 mL; NH₃, 12.7 mmol; H₂, 4.2 mmol; temperature, 170 °C for 18 h.

### DETAILED DESCRIPTION OF THE INVENTION

This approach leverages a dual role of ammonia: (1) as a base to promote dehydrochlorination and (2) as a neutralizing agent that reacts with liberated HCl to form NH₄Cl. The alcohol solvent plays a crucial role beyond solvation, enabling dechlorination chemistry that does not proceed in non-alcoholic aprotic polar solvents like tetrahydrofuran. Solvent optimization studies reveal that increasing NH₃ concentration relative to the alcohol (i.e., reducing alcohol volume) can improve NH₄Cl yields, demonstrating that the dechlorination efficiency is driven not only by NH₃ quantity but also by its effective concentration in the reaction medium.

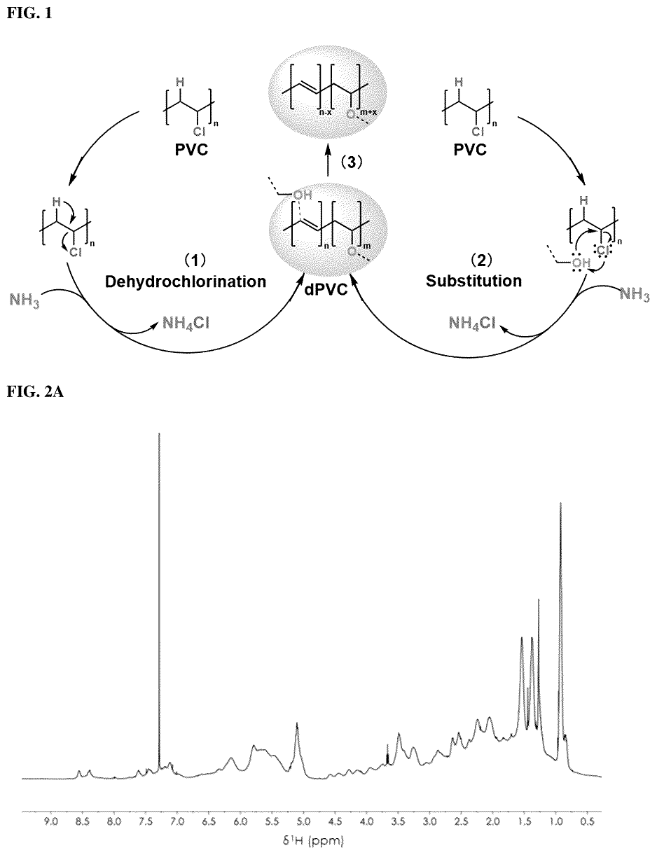

Spectroscopic and elemental analyses (NMR, ATR-FTIR, HSQC, elemental analysis) of the dPVC products confirm the incorporation of unsaturated C═C bonds and ether linkages (e.g., —CH—O—CH₂—). These structural motifs suggest multiple parallel dechlorination pathways (FIG. 1), including: (1) NH₃-mediated elimination to generate unsaturated sites; (2) nucleophilic substitution of chloride by alcohols; and (3) addition of alcohols to in situ generated alkenes. These insights point to early-stage alcohol reactivity that generates defect sites, which subsequently facilitate NH₃-mediated dehydrochlorination.

The combined effect of these pathways leads to the unique stability and properties of the dPVC product, which is readily separable from the NH₄Cl product via diethyl ether extraction and centrifugation, followed by rotary evaporation to isolate the polymer. Its solubility and functional group content expand its potential uses in coatings, resins, and specialty polymers. Furthermore, the material can be subjected to downstream transformations, such as hydrogenation, deoxygenation, or oxidation, to yield hydrocarbons, polyethylene analogues, or oxygenated fine chemicals, respectively.

### Commercial Applications

This technology addresses a long-standing obstacle in plastic recycling: the treatment of chlorinated polymers such as PVC, which currently lack scalable, safe, and economically viable recycling options. With global PVC production projected to exceed US$96 billion by 2030, the development of efficient dechlorination strategies is critical. This platform enables complete dechlorination of PVC at only 150 °C, using no catalysts or expensive solvents, and generates two valuable output streams: soluble, functionalized dPVC and crystalline NH₄Cl. The former retains the polymeric backbone, incorporating unsaturated and ether functionalities that open access to downstream transformations and applications in specialty polymers, coatings, or even polyethylene-like materials. With in situ hydrogenation, fuel detergent additives and lubricants/waxes can be produced in one step. The latter offers direct utility as a fertilizer-grade product.

The method avoids the generation of corrosive HCl gas and prevents the formation of polyaromatic char, which typically renders the carbon skeleton of PVC unusable. As such, it simultaneously addresses safety concerns, environmental risks, and economic inefficiencies that have hampered previous efforts in PVC upcycling. More broadly, this technology introduces a scalable preprocessing step that can be integrated into mixed plastic recycling streams. In pyrolysis operations, even trace amounts of PVC necessitate expensive gas scrubbing, corrosion-resistant reactors, and strict feedstock purification. The ability to pre-remove chlorine while stabilizing the carbon framework unlocks two distinct valorization pathways. Firstly, the dPVC can be used directly as a polymeric material, with potential markets in construction compounds and engineered resins. Initial regional demand, for instance in the Texas industrial corridor, is estimated at 5,000 to 10,000 metric tons per year, with achievable pricing between US$500 and US$800 per ton. This pathway aligns with circular economy initiatives and may attract industry partners seeking to close the loop on polymer materials. Secondly, the process offers a route to produce hydrocarbon liquids or gases through hydrogenation and deoxygenation of dPVC. While this option yields commodity fuels or intermediates priced around US$300 to US$500 per ton, it supports rapid waste volume reduction and revenue generation, particularly for operators already engaged in downstream chemical valorization. In situ hydrogenation can further unlock the production of fuel detergent additives and lubricants/waxes priced around US$2,000 to US$5,000 per ton and US$700 to US$1,800 per ton, respectively.

### Market Differentiation

Compared to high-temperature cracking or ionic liquid methods, this technology offers a uniquely safe, selective, and low-cost approach operating at mild conditions. The system can be adapted for deployment in centralized facilities or modular distributed units, making it suitable for integration at municipal waste sites, materials recovery facilities (MRFs), or adjacent to pyrolysis plants. Most notably, it preserves the material value of both chlorine and carbon, enabling full-feedstock valorization and eliminating a key contaminant in the plastic waste stream. In contrast to current practices that discard PVC outright due to its incompatibility with other recycling processes, this method transforms it into two monetizable products. This unlocks new revenue streams and reduces the environmental burden of landfill or incineration practices. By directly targeting the challenge of chlorine contamination, this platform fills an unmet need in the circular plastics economy and offers a pathway for companies to recover value from a class of materials previously regarded as unprocessable.

In one aspect, the present disclosure provides methods of making a dechlorinated polymer comprising the steps of:
contacting a chlorinated polymer with an alcohol and ammonia, thereby forming a mixture; and
heating the mixture to from about 125 °C to about 250 °C;
thereby producing the dechlorinated polymer and chloride.

In certain embodiments, the chlorinated polymer is polyvinyl chloride (PVC), and the dechlorinated polymer is polyvinyl. In certain preferred embodiments, the chloride is ammonium chloride. In certain embodiments, the chloride is not hydrochloride. In certain embodiments, the method does not produce hydrogen chloride gas.

In certain embodiments, the mixture is heated to about 150 °C to about 200 °C (e.g., at about 150 °C or about 200 °C). In certain preferred embodiments, the mixture is heated to about 160 °C to about 170 °C. In certain embodiments, the mixture is heated for about 12 hours to about 100 hours (e.g., 48 hours). In other embodiments, the mixture is heated for about 18 hours to about 48 hours.

In certain embodiments, the alcohol is an aliphatic alcohol (e.g., a C₃-C₇ alcohol). In certain embodiments, the alcohol is a primary alcohol. In other embodiments, the alcohol is a secondary alcohol. In certain embodiments, the alcohol is selected from the group consisting of 1-propanol, 1-butanol, 1-pentanol, 1-hexanol, 1-heptanol, and 2-butanol. In certain preferred embodiments, the alcohol is 1-butanol. In other preferred embodiments, the alcohol is 2-butanol. In certain embodiments, the alcohol is in an ethereal solvent (e.g., tetrahydrofuran).

In certain embodiments, the method further comprises the step of contacting the mixture with ice after heating the mixture. In certain embodiments, contacting the chlorinated polymer with the alcohol and the ammonia comprises contacting the reaction mixture with ammonia at a pressure of about 60 to about 300 psig (e.g., 80 psig or 240 psig). In other embodiments, contacting the chlorinated polymer with the alcohol and the ammonia comprises contacting the mixture with ammonia at a pressure of about 160 psig to about 320 psig. In certain embodiments, heating the mixture is performed in a sealed reactor.

In certain preferred embodiments, the method has a dechlorination efficiency (DE) of greater than about 99% (e.g., about 99% or about 100%). In certain embodiments, the method has a dechlorination efficiency (DE) of about 99.5%. In yet other embodiments, the method has a dechlorination efficiency (DE) of about 100%.

In certain embodiments, the method further comprises separating the dechlorinated polymer from the chloride (e.g., ammonium chloride). In certain embodiments, separating the dechlorinated polymer from the ammonium chloride comprises extracting the mixture with an ethereal solvent (e.g., diethyl ether) thereby forming an extracted mixture and then washing the extracted mixture with water.

In certain embodiments, the method has an ether selectivity (ORS) of about 20% to about 50%. In certain embodiments, the method has an ether selectivity (ORS) of about 25% to about 45%. In certain embodiments, the method has an ether selectivity (ORS) of about 30% to about 40%.

In certain embodiments, the chlorinated polymer is a post-consumer PVC commodity. In certain embodiments, the post-consumer PVC commodity is selected from the group consisting of PVC bags, PVC tubing, PVC toys, PVC pipes, and PVC pipe connectors.

In certain embodiments, contacting the chlorinated polymer with an alcohol and ammonia further comprises contacting the mixture with a polyolefin. In certain embodiments, the polyolefin is selected from the group consisting of high-density polyethylene (HDPE), low-density polyethylene (LDPE), and polypropylene (PP).

In certain embodiments, the method further comprises contacting the mixture with an iodide catalyst. In certain embodiments, the iodide catalyst is selected from the group consisting of sodium iodide (NaI) and ammonium iodide (NH₄I). In certain embodiments, the iodide catalyst is present in an amount of about 0.1 mol % to about 10 mol % relative to the chlorinated polymer. In certain embodiments, the iodide catalyst is present in an amount of about 1 mol % to about 5 mol % relative to the chlorinated polymer.

In certain embodiments, the method further comprises contacting the mixture with hydrogen and a hydrogenation catalyst, thereby producing a hydrogenated dechlorinated polymer. In certain embodiments, the hydrogenation catalyst is selected from the group consisting of platinum on carbon (Pt/C), ruthenium on carbon (Ru/C), nickel on carbon (Ni/C), palladium on carbon (Pd/C), rhodium on carbon (Rh/C), iridium on carbon (Ir/C), silver on carbon (Ag/C), gold on carbon (Au/C), and copper on carbon (Cu/C). In certain embodiments, the hydrogenation catalyst comprises a support selected from the group consisting of carbon, silica (SiO₂), alumina (Al₂O₃), zirconia (ZrO₂), ceria (CeO₂), and titania (TiO₂). In certain embodiments, the hydrogenation catalyst is a supported alloy catalyst selected from the group consisting of PtNi/SiO₂, PtCo/SiO₂, PtSn/SiO₂, PtAu/SiO₂, PdNi/SiO₂, and PdAg/SiO₂.

In certain embodiments, the hydrogenation catalyst comprises about 1 wt % to about 10 wt % metal on a support. In certain preferred embodiments, the hydrogenation catalyst comprises about 5.0 wt % metal on a support. In certain embodiments, the hydrogenation catalyst is present in an amount of about 2.5 wt % to about 7.5 wt % relative to the chlorinated polymer. In other embodiments, the hydrogenation catalyst is present in an amount of about 5.0 wt % relative to the chlorinated polymer. In certain embodiments where the method comprises contacting the mixture with hydrogen and a hydrogenation catalyst, the alcohol is 2-butanol. In certain embodiments, the hydrogenated dechlorinated polymer is a polyalkylene (e.g., polyethylene).

In certain preferred embodiments, the method produces ammonium chloride in a yield exceeding about 93 mol % relative to the chlorine content of the chlorinated polymer. In certain embodiments, the chloride (e.g., ammonium chloride) yield is about 99 mol % or greater relative to the chlorine content of the chlorinated polymer. In certain embodiments, the ammonium chloride yield is about 95 mol % to about 99 mol % relative to the chlorine content of the chlorinated polymer. In certain embodiments, the ammonium chloride yield is about 97 mol % to about 100 mol % relative to the chlorine content of the chlorinated polymer.

In certain embodiments, the method produces a dechlorinated polymer having a nitrogen content of about 1 wt % to about 7 wt %. In certain embodiments, the dechlorinated polymer has a nitrogen content of about 1 wt % to about 3 wt %. In other embodiments, the dechlorinated polymer has a nitrogen content of about 5 wt % to about 7 wt %. In certain embodiments, the dechlorinated polymer has a nitrogen content of about 6 wt %. In certain embodiments, the nitrogen in the dechlorinated polymer comprises amine groups or pyridyl groups.

In certain preferred embodiments, the method produces the dechlorinated polymer substantially free of polyaromatic char.

In certain embodiments, the dechlorinated polymer is soluble in diethyl ether, tetrahydrofuran, or chloroform.

In certain embodiments, the dechlorinated polymer comprises carbon-carbon double bonds (e.g., in the backbone of the carbon chain). In certain embodiments, the dechlorinated polymer comprises ether linkages (e.g., in side chains).

In certain embodiments, the chlorinated polymer is present in an amount of about 200 mg to about 1000 mg per 5 mL of alcohol. In certain embodiments, the chlorinated polymer is present in an amount of about 200 mg to about 500 mg per 5 mL of alcohol.

In certain embodiments, the dechlorinated polymer or the ammonium chloride is recovered as a valorized product. In certain embodiments, the mixture is substantially free of water.

In certain embodiments, the method is performed in the absence of an alkali metal hydroxide.

### DEFINITIONS

Unless otherwise defined herein, scientific and technical terms used in this application shall have the meanings that are commonly understood by those of ordinary skill in the art. Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

It is understood that substituents and substitution patterns on the compounds of the present invention can be selected by one of ordinary skilled person in the art to result chemically stable compounds which can be readily synthesized by techniques known in the art, as well as those methods set forth below, from readily available starting materials. If a substituent is itself substituted with more than one group, it is understood that these multiple groups may be on the same carbon or on different carbons, so long as a stable structure results.

As used herein, the term “optionally substituted” refers to the replacement of one to six hydrogen radicals in a given structure with the radical of a specified substituent including, but not limited to: hydroxyl, hydroxyalkyl, alkoxy, halogen, alkyl, nitro, silyl, acyl, acyloxy, aryl, cycloalkyl, heterocyclyl, amino, aminoalkyl, cyano, haloalkyl, haloalkoxy, —OCO—CH₂—O-alkyl, —OP(O)(O-alkyl)₂ or —CH₂—OP(O)(O-alkyl)₂. Preferably, “optionally substituted” refers to the replacement of one to four hydrogen radicals in a given structure with the substituents mentioned above. More preferably, one to three hydrogen radicals are replaced by the substituents as mentioned above. It is understood that the substituent can be further substituted.

As used herein, the term “alkyl” refers to saturated aliphatic groups, including but not limited to C₁-C₁₀ straight-chain alkyl groups or C₁-C₁₀ branched-chain alkyl groups. Preferably, the “alkyl” group refers to C₁-C₆ straight-chain alkyl groups or C₁-C₆ branched-chain alkyl groups. Most preferably, the “alkyl” group refers to C₁-C₄ straight-chain alkyl groups or C₁-C₄ branched-chain alkyl groups. Examples of “alkyl” include, but are not limited to, methyl, ethyl, 1-propyl, 2-propyl, n-butyl, sec-butyl, tert-butyl, 1-pentyl, 2-pentyl, 3-pentyl, neo-pentyl, 1-hexyl, 2-hexyl, 3-hexyl, 1-heptyl, 2-heptyl, 3-heptyl, 4-heptyl, 1-octyl, 2-octyl, 3-octyl or 4-octyl and the like. Moreover, the term “alkyl” as used throughout the specification, examples, and claims is intended to include both unsubstituted and substituted alkyl groups, the latter of which refers to alkyl moieties having substituents replacing a hydrogen on one or more carbons of the hydrocarbon backbone, including haloalkyl groups such as trifluoromethyl and 2,2,2-trifluoroethyl, etc.

The term “hydroxyalkyl”, as used herein, refers to an alkyl group substituted with a hydroxy group.

The term “lower” when used in conjunction with a chemical moiety, such as, acyl, acyloxy, alkyl, alkenyl, alkynyl, or alkoxy is meant to include groups where there are ten or fewer atoms in the substituent, preferably six or fewer. A “lower alkyl”, for example, refers to an alkyl group that contains ten or fewer carbon atoms, preferably six or fewer. In certain embodiments, acyl, acyloxy, alkyl, alkenyl, alkynyl, or alkoxy substituents defined herein are respectively lower acyl, lower acyloxy, lower alkyl, lower alkenyl, lower alkynyl, or lower alkoxy, whether they appear alone or in combination with other substituents, such as in the recitations hydroxyalkyl and aralkyl (in which case, for example, the atoms within the aryl group are not counted when counting the carbon atoms in the alkyl substituent).

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, heteroatoms, such as nitrogen, may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate.

As used herein, the term “ether selectivity” or “ORS” refers to a metric that quantifies the proportion of chlorine atoms removed from a chlorinated polymer (e.g., PVC) via substitution with alkoxy moieties, thereby forming ether moieties, relative to the total chlorine removed from the chlorinated polymer during dechlorination and is expressed as a percentage.

### EXAMPLES

The invention now being generally described, it will be more readily understood by reference to the following examples which are included merely for purposes of illustration of certain aspects and embodiments of the present invention and are not intended to limit the invention.

### Example 1: Exemplary Dechlorination Methods

The invention involves the treatment of PVC at elevated temperatures (150-200 °C) in a sealed reactor pressurized with NH₃ and using aliphatic (typically C₃-C₇) alcohol as the reaction solvent. In a typical reaction, 221 mg PVC and 5 mL alcohol are added to a 25 mL Hastelloy Parr reactor; the reactor is subsequently sealed and charged with 80-240 psig NH₃ in 80 psig cycles (vide infra). The reactor is then heated to the desired reaction temperature for the desired reaction time (up to 48 hours), then quenched in ice. The reaction mixture is extracted via repeated washing with diethyl ether; remaining insoluble products, mostly NH₄Cl salts, are extracted by repeated washing with MilliQ water (H₂O). The diethyl ether fraction is centrifuged, and the supernatant is evaporated using a rotary evaporator to obtain the soluble dPVC product; the insoluble solids after centrifugation (NH₄Cl, unreacted and/or insoluble dPVC) are combined with those from the aqueous fraction. Additional H₂O is added to the aqueous fraction to ensure full dissolution of NH₄Cl, and the resulting solution is filtered to separate any remaining insoluble solids, which were collected and dried overnight in a vacuum oven.

The amount of NH₄Cl produced was quantified by measuring NH₄⁺ via ¹H NMR and Cl⁻ via ion chromatography (IC). A typical ¹H NMR sample for measuring NH₄⁺ was prepared by adding 600 μL aliquot of the filtered solution, 70 μL of deuterium oxide (D₂O) containing maleic acid (MA) as the internal standard, and 30 μL of 4M sulfuric acid (H₂SO₄). NMR spectra were collected on a Bruker Avance Neo 500 MHz spectrometer, with 32 scans and 50 s relaxation delay. The quantity of NH₄⁺ was determined by using the premade calibration curves correlating the normalized NH₄⁺ integral (area of NH₄⁺ peak/area of MA peak) with NH₄⁺ concentration. A typical IC sample for measuring Cl⁻ was prepared by adding 500 μL aliquot of the filtered solution into an IC vial. IC spectra were collected using a Dionex Aquion IC system containing a Dionex IonPac AS23-4 μm analytical column, a Dionex anion electrolytically regenerated suppressor, as well as a Dionex carbonate removal device (CRD). The quantity of Cl⁻ was determined by using the premade calibration curves correlating the area of Cl⁻ peak with Cl⁻ concentration.

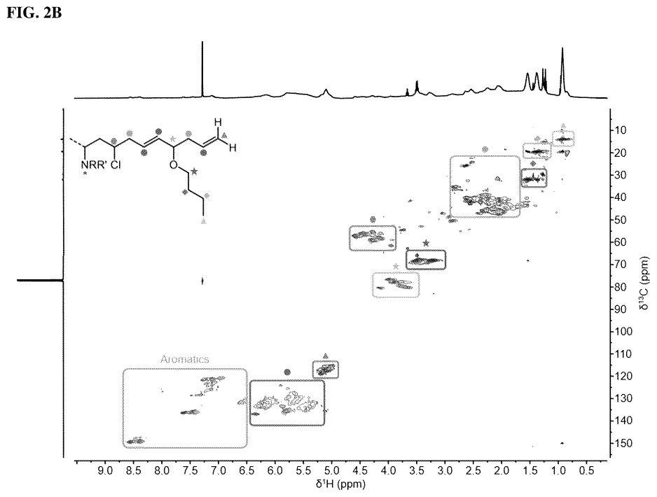

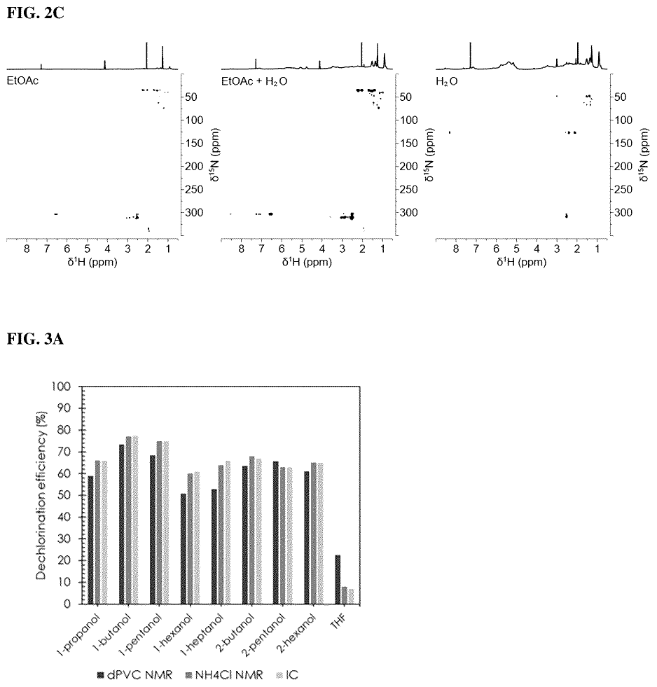

The dPVC product was characterized via ¹H, ¹³C, and ¹H-¹³C Heteronuclear Single Quantum Coherence (HSQC) NMR spectroscopy. FIGS. 2A-2C show representative ¹H and ¹H-¹³C HSQC NMR spectra from dechlorination of PVC in 1-butanol at 150 °C for 18 hours. The diversity of chemical moieties in the dPVC backbone did not allow for precise assignment of individual species; however, the HSQC NMR enabled identification of several functional groups in the dPVC, including —CHCl groups (δ¹H=4.1-4.7 ppm; δ¹³C=55-60 ppm), —CH₂-groups (δ¹H=1.2-3.0 ppm; δ¹³C=35-50 ppm), internal alkenes (—HC—CH—, δ¹H=5.25-6.5 ppm; δ¹³C=115-150 ppm), terminal alkenes (—HC═CH₂, δ¹H=4.9-5.25 ppm; δ¹³C=115-120 ppm) aromatics (δ¹H=6.5-9.0 ppm; δ¹³C=115-150 ppm), and ethers (HC—OR, δ¹H=0.7-3.6 ppm; δ¹³C=15-70 ppm). These assignments enabled the integration of ¹H NMR spectra as a tool for approximate quantification of the various functional groups present in the dPVC. Quantification of —CHCl and ether groups using ¹H NMR yielded results in good agreement with both NH₄Cl yield and C/H/N/Cl elemental analysis, respectively, suggesting that this method is effective for determining the composition of dPVC samples.

Metrics for tracking the progression of reaction include dechlorination efficiency (DE), ether efficiency (ORE), and ether selectivity (ORS). Dechlorination efficiency is defined as:

$$DE ( \% ) = 100 \% \cdot ( 1 - \frac{moles Cl in dPVC}{moles Cl in PVC} ) = N {H}_{4} Cl yield ( \% ) \qquad ( 1 )$$

Similarly, ORE is defined as:

$$ORE ( \% ) = 100 \% \cdot \frac{moles ether on dPVC backbone}{moles Cl in PVC} \qquad ( 2 )$$

While ORS is determined with respect to the amount of Cl removed:

$$ORS ( \% ) = 100 \% \cdot \frac{moles erther on dPVC backbone}{moles Cl removed} = 100 \% \cdot \frac{ORE}{D E} \qquad ( 3 )$$

DE was determined both by determining NH₄Cl yield with ¹H NMR and IC and by measuring the residual chlorine content of the soluble dPVC with ¹H NMR. ORE and ORS were determined using the ¹H NMR spectra of the soluble dPVC and verified with C/H/N/Cl elemental analysis.

Elemental analysis of dPVC detected the existence of element nitrogen (Table 1), suggesting possible nitrogen incorporation into the dPVC structure.

TABLE 1
Elemental distribution of dPVC obtained from elemental analysis.

| | m_{PVC} | | dPVC | P_{NH3} | T | t | C | H | N | Cl | O |
|---|---|---|---|---|---|---|---|---|---|---|---|
| Entry | (mg) | Solvent | Type | (psig) | (°C) | (h) | (wt %) | (wt %) | (wt %) | (wt %) | (wt %) |
| 1 | 221 | nC4-ol | i | 80 | 200 | 18 | 76.63 | 7.77 | 1.58 | 6.41 | 7.61 |
| 2 | 221 | nC4-ol | s | 160 | 150 | 48 | 77.28 | 9.66 | 6.00 | 1.00 | 6.06 |
| 3 | 221 | nC4-ol | s | 160 | 170 | 18 | 76.27 | 9.43 | 6.15 | 2.51 | 5.64 |
| 4 | 221 | nC4-ol | i | 160 | 170 | 2 | 46.42 | 5.89 | 1.27 | 36.63 | 9.79 |
| 5 | 221 | nC4-ol | s | 160 | 170 | 2 | 54.35 | 7.15 | 2.11 | 33.23 | 3.16 |
| 6 | 221 | nC5-ol | s | 160 | 170 | 18 | 77.66 | 9.74 | 6.09 | 1.29 | 5.22 |

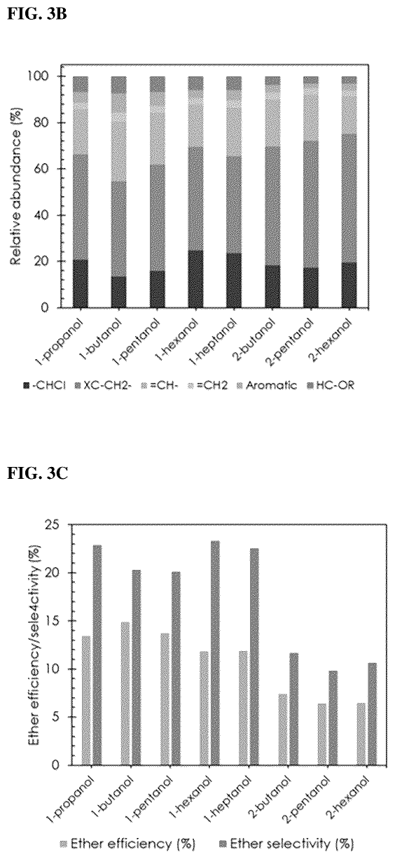

m_{PVC}, P_{NH3}, T, t, nC4-ol, nC5-ol, and i/s stand for PVC loading, NH₃ filling pressure, reaction temperature, reaction time, 1-butanol, 1-pentanol, as well as insoluble/soluble dPVC, respectively. Unless otherwise specified, PVC powders are the PVC substrate, and the solvent volume is 5 mL.
¹⁵N-enriched NH₃, which was used to trace the form of nitrogen species, revealed the emergence of amines (δ¹⁵N = 0-100 ppm), amides (δ¹⁵N = 120-130 ppm), and pyridinic nitrogens (δ¹⁵N = 300-350 ppm) (FIG. 3). Since the amide peaks were not observed in the organic phase when performing liquid-liquid extraction using ethyl acetate and water mixture, amides are likely side products formed during the reaction, suggesting that the dominant nitrogen species in soluble dPVC are mainly amines and pyridinic nitrogens.

Similar to ORY and ORS, nitrogen yield (NY) and nitrogen selectivity (NS) are defined as:

$$NY ( \% ) = 100 \% \cdot \frac{moles nitrogen on dPVC backbone}{moles Cl in PVC} \qquad ( 6 )$$

$$NS ( \% ) = 100 \% \cdot \frac{moles nitrogen on dPVC backbone}{moles Cl removed} = 100 \% \cdot \frac{NY}{D E} \qquad ( 7 )$$

Since nitrogen content was not quantifiable from ¹H NMR, NY and NS were determined using the C/H/N/Cl elemental analysis.

### Screening of Different Solvents

FIGS. 3A-3C show the dechlorination efficiency (DE), dPVC chemical composition, and ether efficiency/selectivity (ORE/ORS), respectively, for PVC ammonolysis/alcoholysis at 150 °C using NH₃ and C₃-C₇ alcohols. At the conditions tested, PVC dechlorination in alcohols resulted in >50% DE; in contrast, an experiment using tetrahydrofuran (THF) as a solvent resulted in a DE of only 13%, despite PVC having higher solubility in THF than in alcohols. PVC dechlorination in 1-butanol and 1-pentanol showed the highest DEs of the solvents tested.

The composition of the dPVC obtained suggests similar mechanisms of dechlorination occurred with all alcohol solvents. ¹H NMR spectra of the dPVC indicate competing elimination (dehydrochlorination) and substitution reactions, with signals corresponding to alkene (C═C), aromatic, and ether (R—OR) moieties increasing along with DE. Dechlorination with 2-alcohols resulted in lower ORE/ORS values, indicating that the elimination reaction was more favorable when using 2-alcohols than 1-alcohols (FIG. 3C. Reactions run with 2-alcohols and 1-propanol also produced an insoluble dPVC fraction, which is presumed to result from rapid charring (conjugation/aromatization) of the PVC backbone. Interestingly, running the dechlorination reaction using 1-butanol, 1-pentanol, 1-hexanol, or 1-heptanol as a solvent did not result in the production of insoluble dPVC, suggesting that the presence of the alcohol stabilizes the polymer backbone. Based on the results of the solvent screening, 1-butanol was identified as a promising candidate for further PVC dechlorination experiments.

### Further Screening of Solvents

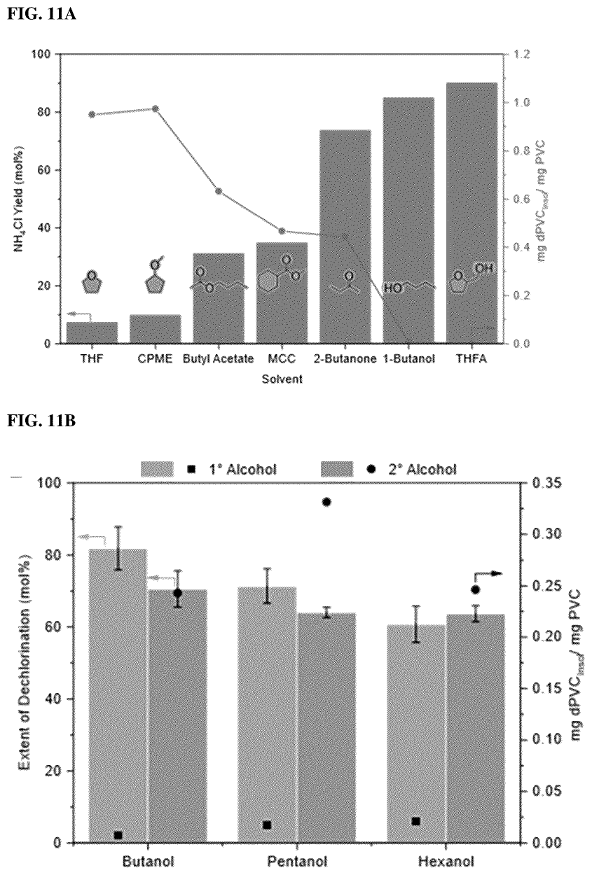

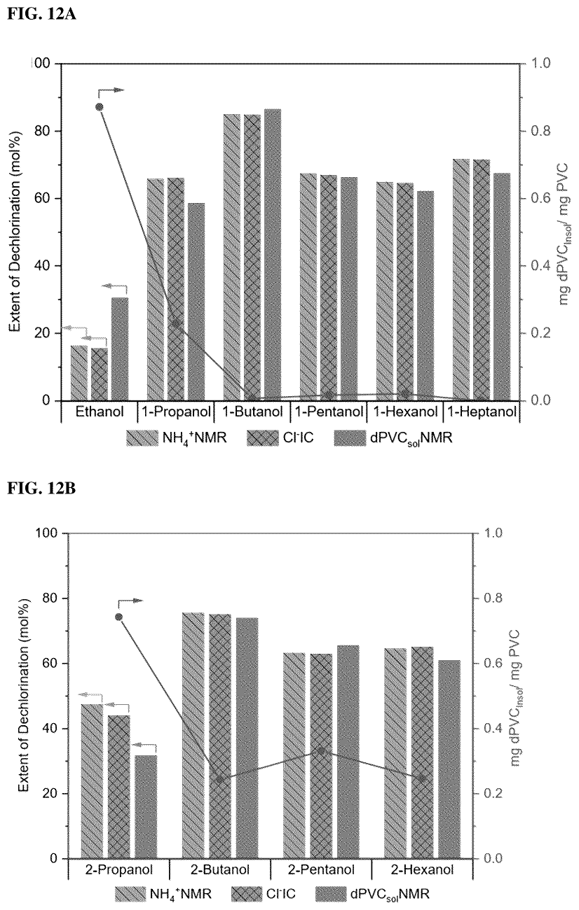

PVC dechlorination with NH₃ was investigated in various solvents including ethers, esters, ketones, and alcohols at 150 °C (FIGS. 11A and 11B). THF, an effective solvent for PVC dissolution at room temperature, resulted in minimal dechlorination (<10 mol %). In contrast, reactions in alcohols such as 1-butanol and tetrahydrofurfuryl alcohol (THFA) substantially enhanced PVC dechlorination and resulted in soluble polymeric products after reaction. This observation led to investigation of PVC dechlorination in primary and secondary aliphatic alcohols (FIG. 11B). Compared with secondary alcohols, reactions in primary alcohols led to slightly higher EOD and less insoluble dPVC, which results from formation of char.

PVC dechlorination with long-chain alcohols (n>4) results in more soluble dPVC than reactions with short-chain alcohols (FIG. 11). Among these alcohols, 1-butanol demonstrated the most appealing results with both the highest EOD (82 mol %) and negligible charring.

In dechlorination reactions with ethanol and 2-propanol, the recovered insoluble dPVC darkened to orange/brown but retained its fine powder morphology from the original PVC, suggesting that the poor solubility of PVC in either alcohol at 150 °C accounts for the high insoluble dPVC content (>0.7 mg dPVC_{Insol}/mg PVC) relative to other alcohols.

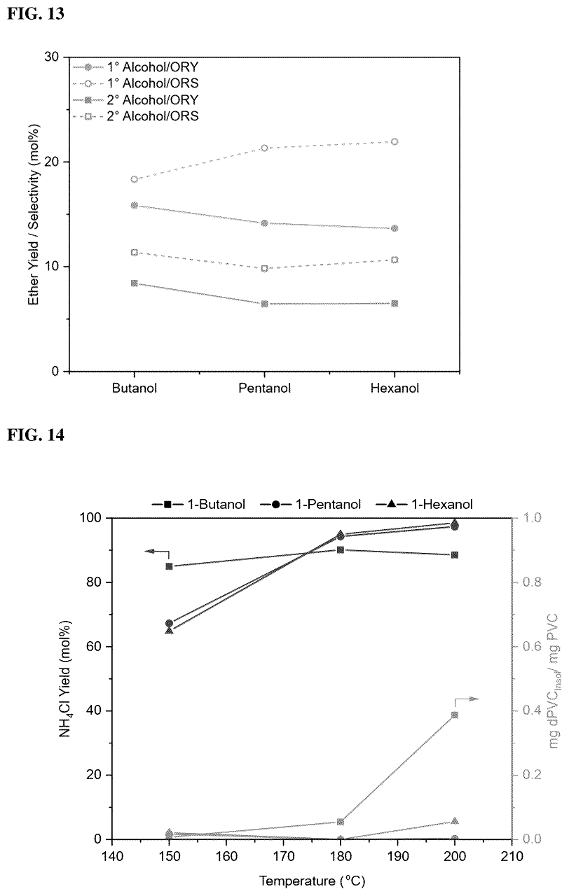

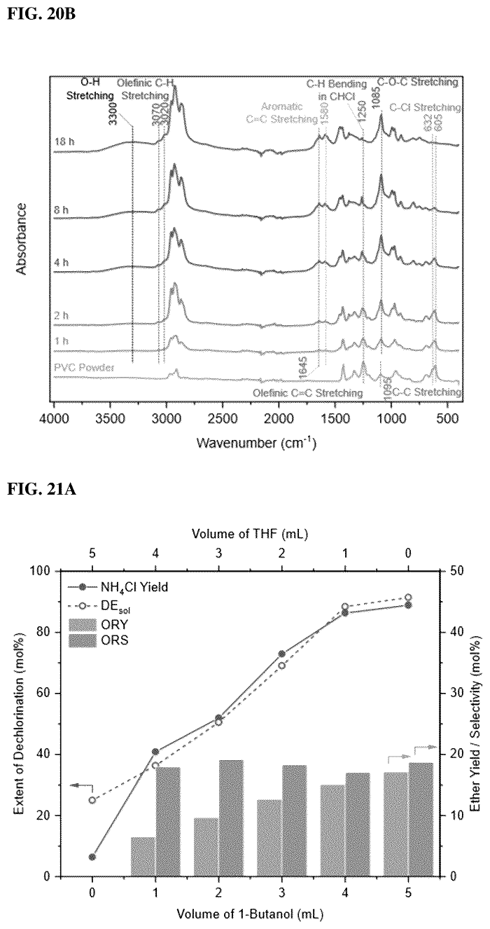

Additionally, NMR quantification of ether incorporation among different alcohols illustrates that primary alcohol solvents facilitate higher ORY and selectivity ORS than secondary alcohols (FIGS. 13 and 20A & 20B). This higher degree of ether incorporation stabilizes the resulting dPVC, resulting in the trend observed in FIG. 11B.

### Screening of Different Ammonia Filling Pressures

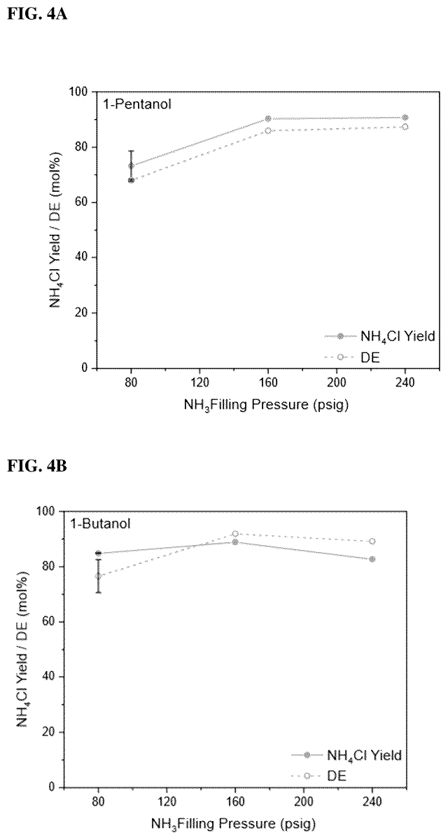

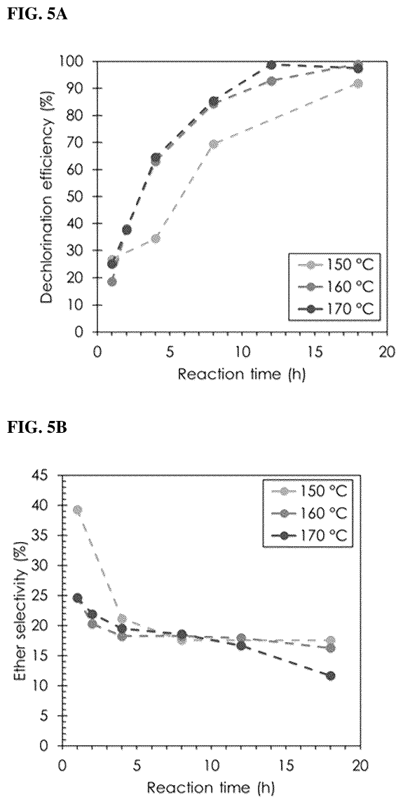

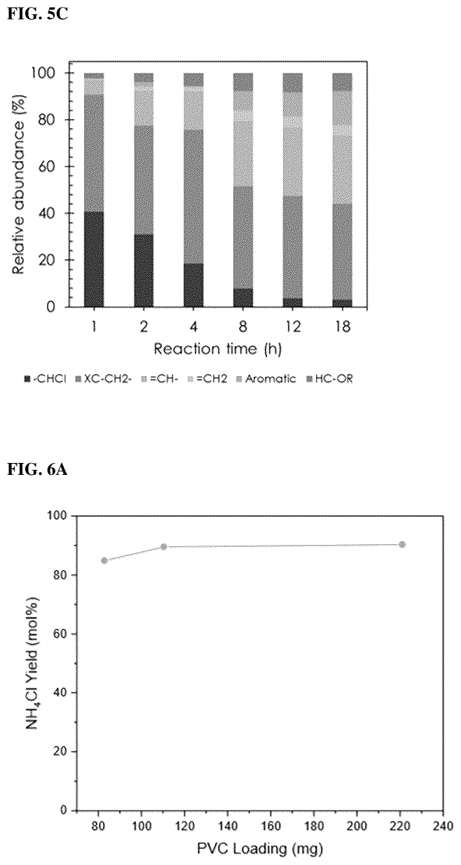

FIGS. 4A and 4B show the influence of NH₃ filling pressure on the DE of PVC upcycling reactions with 1-pentanol and 1-butanol at 150 °C. During pressurization of the reactor, NH₃ could be added in 80 psig intervals; between fillings, stirring of the reactor contents allowed for full solubilization of NH₃ in alcohol solvents, enabling multiple NH₃ filling cycles. In general, NH₃ loading can influence the DE in the range tested. For instance, increasing NH₃ loading from one to two filling cycles (80 to 160 psig) in 1-pentanol resulted in a ~20% increase in DE and NH₄Cl yield, suggesting that NH₃ loading influences the rate of dechlorination as it approaches stoichiometric loadings with respect to Cl. Increasing the NH₃ loading further had no significant impact on the DE. In 1-butanol, increasing NH₃ loading did not have a significant effect on the rate of dechlorination in the range tested. This result demonstrates that the identity of the alcohol solvent used can affect the behavior of NH₃ during the reaction.

Subsequent experiments reported here were conducted with ≥2 cycles of NH₃ filling (unless stated otherwise) to ensure the rate of reaction was not influenced by the NH₃ loading.

### Screening of the Effect of Ammonia Loading on PVC Dechlorination

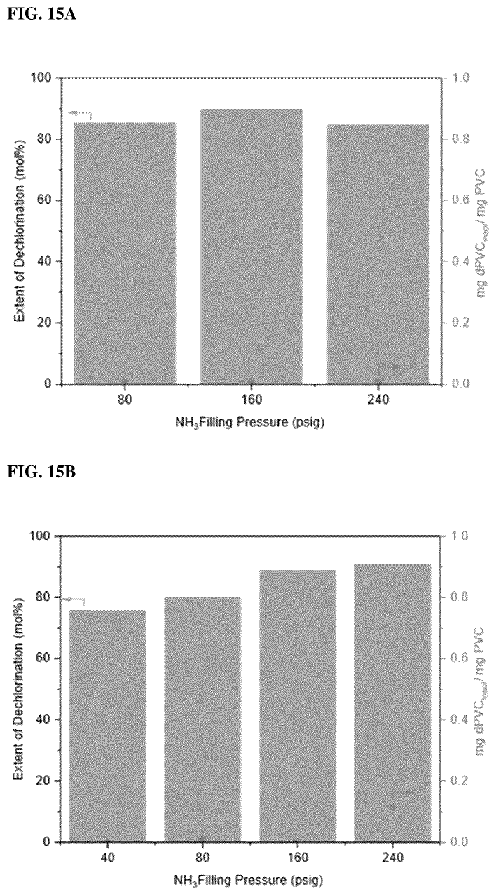

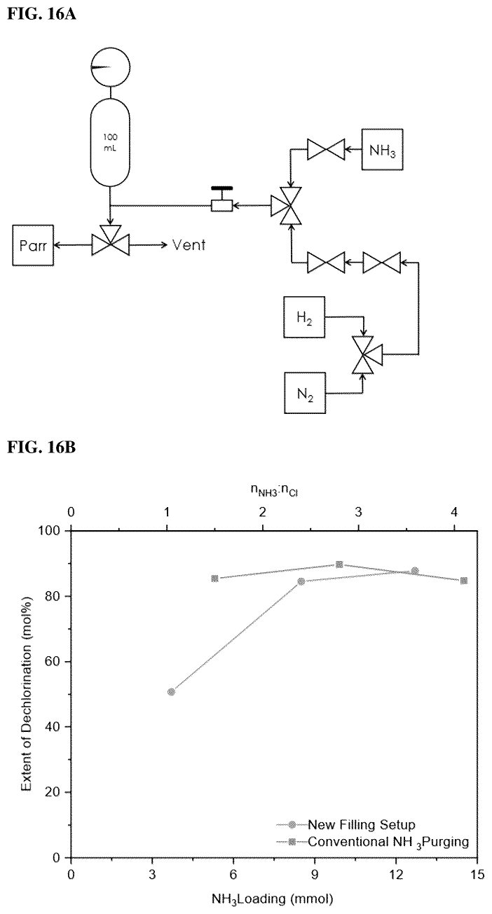

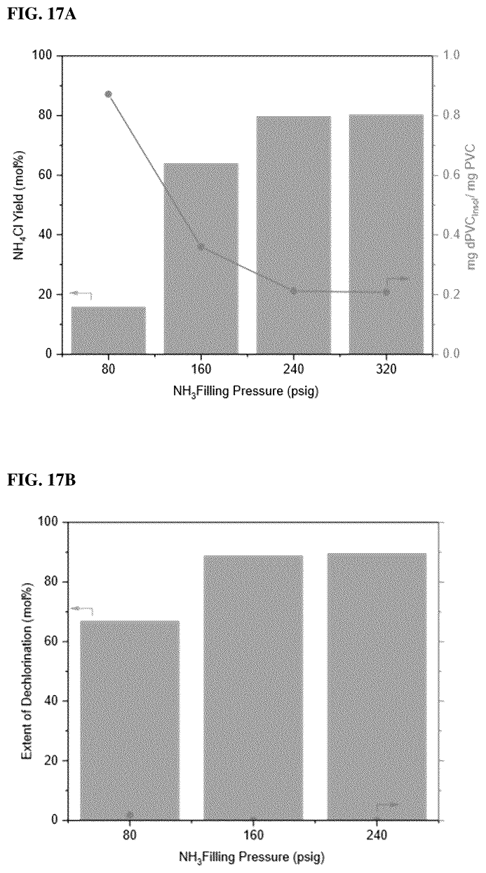

The influence of NH₃ loading on PVC dechlorination was investigated by varying the amount of ammonia charged to the reactor. In a typical experiment, after loading the reactor with PVC and solvent, it was sealed and charged with 40 psig (110 mg PVC scale) or 80 psig NH₃ (221 mg PVC scale). Ammonia was allowed to equilibrate with the alcohol solvent until the reactor pressure reached 0 psig, and then additional 40 or 80 psig filling cycles were performed to reach the desired NH₃ loading. Increasing NH₃ loading from 40 psig to 240 psig resulted in an increase in EOD (FIG. 15). It should be noted that NH₃ can dissolve in 1-butanol during the filling/purging stage, leading to uncertainty in the amount of NH₃ loaded into the reactor. To validate the results presented in FIG. 15, a pre-filled reservoir with a known pressure and volume was used to accurately determine the amount of NH₃ loaded into the reactor (FIG. 16A). With the new filling setup, the increasing trend in EOD with higher NH₃ concentration became more obvious (FIG. 16B).

Increasing NH₃ concentration also increased EOD during PVC dechlorination with other alcohols such as ethanol and 1-pentanol (FIGS. 17A and 17B). In dechlorination reactions using ethanol, increasing NH₃ loading also substantially decreased the mass of insoluble dPVC recovered, suggesting that NH₃ also facilitates dPVC dissolution.

### Screening of Temperatures and Reaction Times

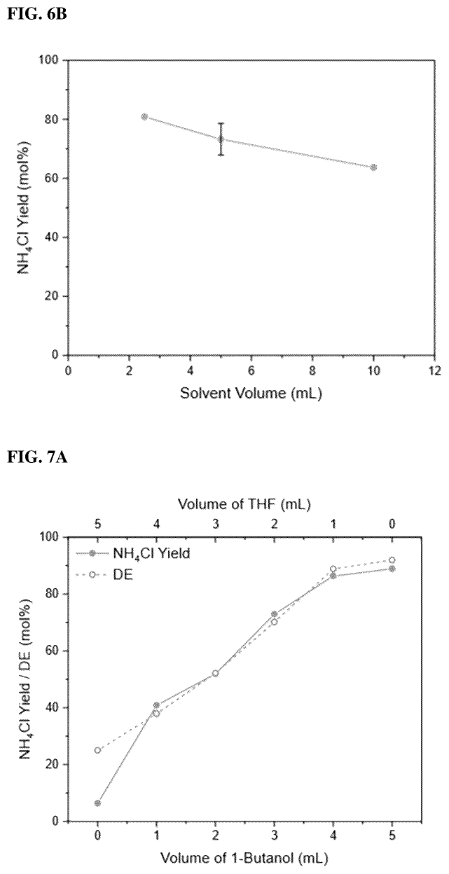

FIGS. 6A and 6B show the progression of the dechlorination reaction as a function of reaction temperature (150-170 °C) and time (1-18 hours) for PVC upcycling with NH₃ and 1-butanol. With increasing reaction time, Cl content decreased concomitant with the generation of alkene, aromatic, and ether functionalities. >99% DE could be obtained in 18 hours at 160 °C or 12 hours at 170 °C. (FIG. 6A). While the rate of dechlorination increased from 150 °C to 160 °C, increasing the temperature to 170 °C had no influence on the rate of dechlorination. Reactions run at 200 °C resulted in incomplete (91%) dechlorination as well as an insoluble dPVC, which likely formed as a result of dehydrochlorination (elimination) and subsequent charring.

FIG. 6B shows ORS as a function of reaction time and temperature. Selectivity towards ether substitution decreases in the first few hours of the reaction but reaches a plateau after ca. 4 hours regardless of reaction temperature. The initial high selectivity towards substitution may suggest that alcohol plays a role in facilitating the elimination reaction as well as the substitution reaction.

### Further Screening of Different Temperatures for Different Reaction Times

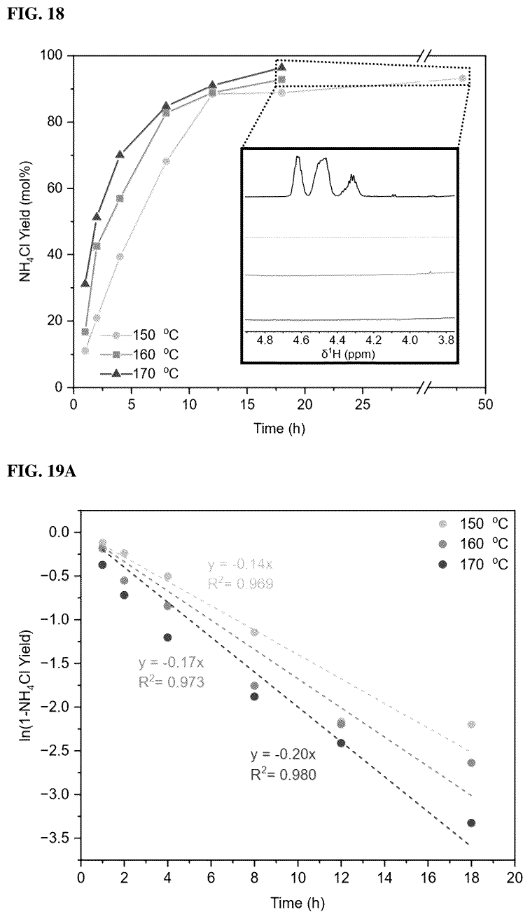

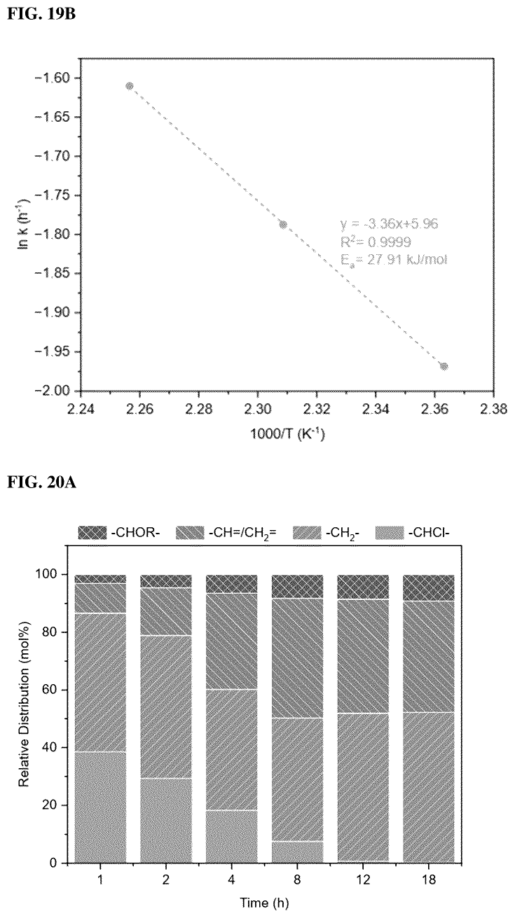

Near-complete dechlorination can be achieved without any char formation when the reaction time reaches 48 h at 150 °C (FIG. 18). The reaction time can be shortened to 18 h at 160 or 170 °C to achieve similar results. By performing a kinetic analysis, it was found that PVC dechlorination is an overall first-order reaction with an apparent activation energy barrier of 27.91 kJ/mol (FIGS. 19A and 19B).

### Screening of Different Temperatures for Different Primary Alcohols

The influence of temperature on PVC dechlorination in 1-butanol, 1-pentanol, and 1-hexanol was explored between 150-200 °C. In 1-butanol, insoluble dPVC content increased from 0.01 mg dPVCᵢₙₛₒₗ/mg PVC at 150 °C to 0.39 mg dPVCᵢₙₛₒₗ/mg PVC at 200 °C with a <5 mol % increase in NH₄Cl yield (FIG. 14). In contrast, PVC dechlorination in both 1-pentanol and 1-hexanol at 200 °C enabled near-quantitative recovery of NH₄Cl (97.3 mol % and 98.5 mol %, respectively) without the formation of insoluble dPVC.

### Screening of Different PVC Concentrations

FIGS. 6A and 6B show the NH₄Cl yield as a function of the concentration of PVC loaded to the reactor at otherwise identical conditions. In FIG. 6A, PVC concentration was varied by directly changing the loading of PVC to the reactor, allowing for comparison at identical alcohol and NH₃ loadings. The NH₄Cl yield was constant at all PVC concentrations, consistent with a reaction order of unity in PVC. In FIG. 6B, PVC and NH₃ loading were held constant while the alcohol volume was increased, decreasing the PVC and NH₃ concentrations. As the rate of reaction is invariant to PVC concentration (FIG. 6A), the increase in NH₄Cl yield is attributable to the effect of variable NH₃ concentration.

### Screening of Different Alcohol Volumes

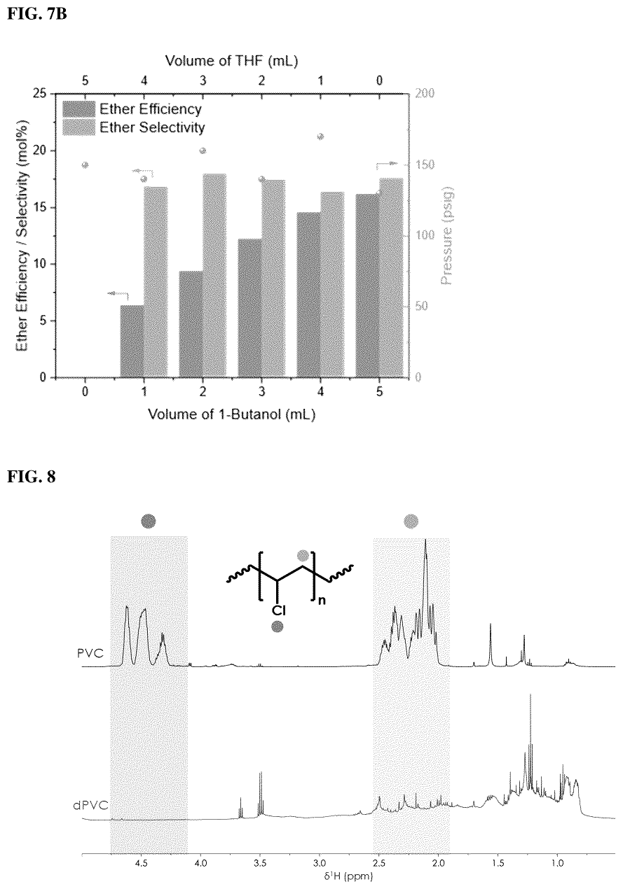

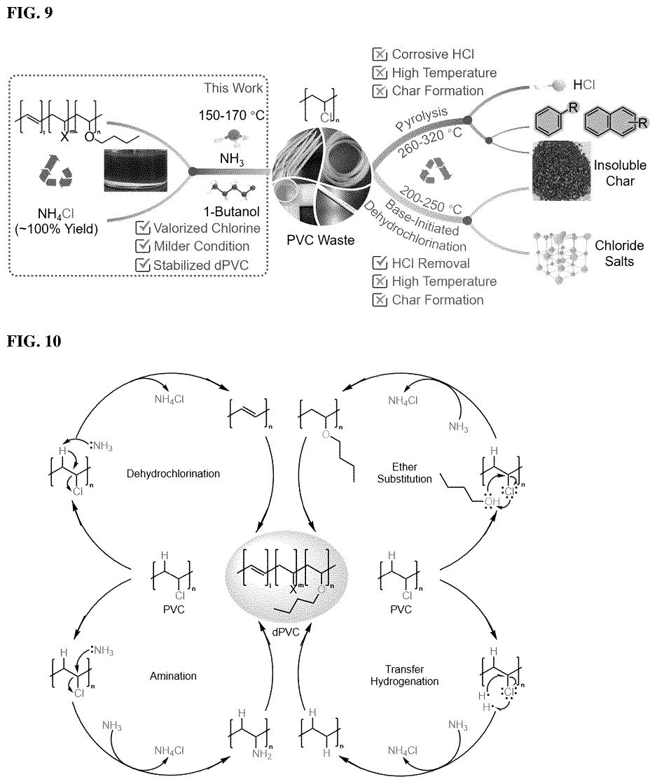

FIGS. 7A and 7B show the DE, NH₄Cl yield, ORE, and ORS for PVC upcycling in solvent mixtures of 1-butanol and THF. THF has previously been demonstrated to be largely unreactive for dechlorination of PVC and thus can be used in combination with 1-butanol to probe the influence of alcohol concentration on the reactivity of PVC while maintaining a constant volume of solvent. Here, the total liquid volume was held constant at 5 mL while increasing the loading of 1-butanol in 1 mL increments from 0 to 5 mL.

DE/NH₄Cl yield increased with an increasing 1-butanol concentration (FIG. 7A), suggesting that the rate of the reaction is dependent on the amount of alcohol used. The reaction pressure was approximately constant across all reactions (FIG. 7B), indicating that a similar quantity of NH₃ was dissolved in the solution at all conditions. ORE also increased with 1-butanol concentration, which can be attributed to an increase in the rate of substitution with alcohol content; however, ORS was invariant as a function of 1-butanol concentration, suggesting that rates of both substitution and elimination increased proportionally with alcohol concentration. This result indicates that alcohol facilitates both elimination and substitution reactions during dechlorination.

### Further Screening of Different Alcohol Concentrations

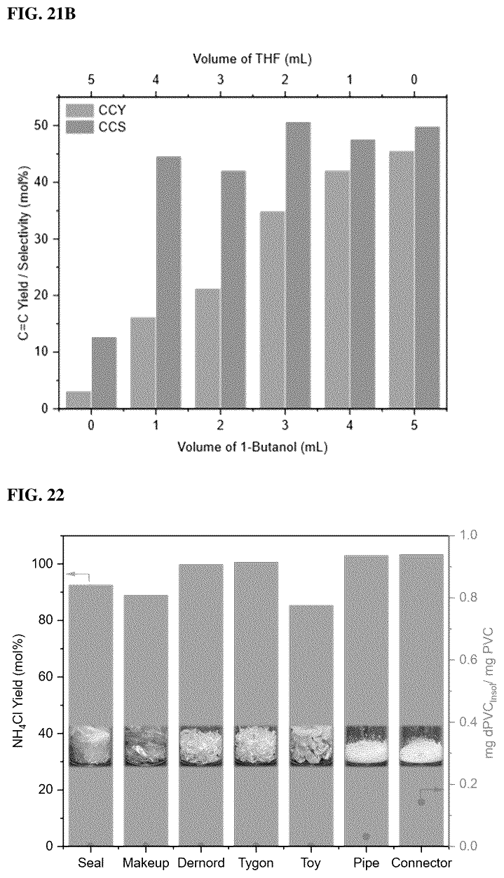

Alcohol concentrations were varied by using mixtures of THE, which is unreactive for PVC dechlorination (FIG. 11A), and 1-butanol to maintain constant total solvent volume of 5 mL. EOD and ORY both increase with 1-butanol concentration, consistent with nucleophilic substitution of chlorine groups with 1-butanol to form ethers (FIG. 21A). ORS remains constant with increasing 1-butanol content, suggesting that the rates of ether substitution and elimination increase proportionally with 1-butanol concentration, which is also supported by the same trend in CCY and CCS (FIG. 21B).

¹H NMR Spectrum of a dPVC Sample with 100% DE

FIG. 8 shows the ¹H NMR spectrum of a 48-hour PVC upcycling reaction with NH₃ and 1-butanol at 150 °C, along with a reference spectrum of the starting PVC substrate (both in CDCl₃). The highlighted regions correspond to —CHCl groups and adjacent-CH₂-groups on the PVC backbone. As the reaction progresses, —CHCl signals decrease in magnitude, while-CH₂-signals broaden as their chemical environment changes. In samples with >99% DE, signals from —CHCl groups disappear entirely (FIG. 8, bottom). Quantification of these samples via NMR becomes more challenging and is supported with additional methods (e.g., elemental analysis & NH₄Cl yield).

### Applicability to PVC Waste

PVC commodities, formulated to contain a complex mixture of fillers, stabilizers, colorants, plasticizers, and additives, are challenging to recycle at their end of life. These materials often end up in landfills, posing long-term environmental and health risks due to the release of toxic chemicals such as phthalates. To resemble post-consumer PVC waste, a series of representative PVC commodities was selected including sealed bags, makeup bags, Dernord and Tygon tubing, toys, pipes, and pipe connectors. NMR and post-reaction gas chromatography-mass spectrometry (GC-MS) reveal the existence of plasticizers such as bis(2-ethylhexyl) phthalate (DEHP), bis(2-ethylhexyl) terephthalate (DEHT), and bio-based plasticizers in PVC bags, tubing, and toys, among which toys also contain green colorants. Without any pretreatment, close to 100% NH₄Cl yield was obtained while solubilizing all the dPVC generated (FIG. 22). The alkoxy groups in ester-based plasticizers were exchanged partially by 1-butanol or NH₃ after the reaction, which can be converted back to their original form via transesterification. Comparable NH₄Cl yield was achieved for pipes and pipe connectors (FIG. 22). A higher amount of solid residues was measured, likely owing to higher content of insoluble additives.

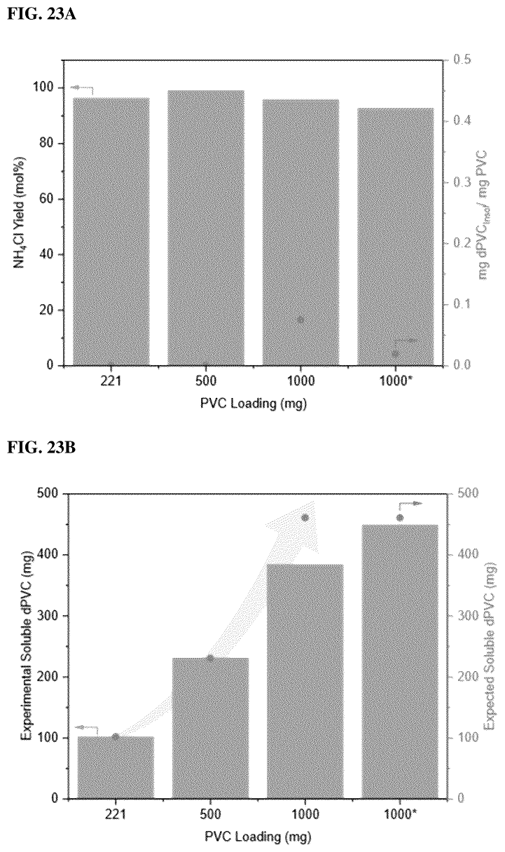

To demonstrate process scalability, the PVC loading was increased to 500 mg and NH₃ filling to 240 psig. An NH₄Cl yield of 99% was achieved without forming any insoluble dPVC (FIG. 23A). Further increasing the PVC loading to 1 g led to incomplete recovery of soluble dPVC and more char formation (FIG. 23B). Lowering the temperature to 150 °C and extending the reaction time to 48 h allowed for reaching a comparable NH₄Cl yield and an expected amount of soluble dPVC (FIGS. 23A and 23B).

### Adaptability to Chlorine-Contaminated Polyolefin Waste

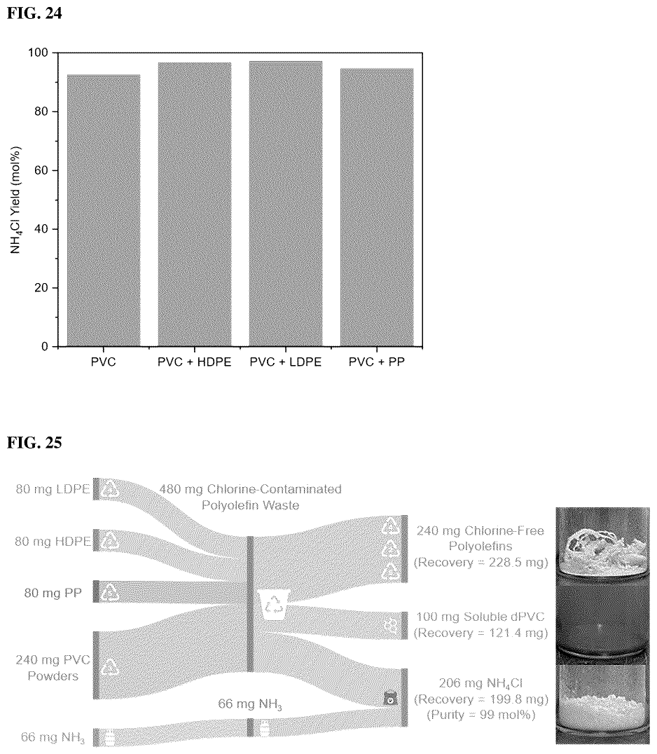

Post-consumer polyolefin waste, composed of high-density polyethylene (HDPE), low-density polyethylene (LDPE), and polypropylene (PP), inevitably contains PVC contaminants. It is of interest to achieve complete dechlorination of chlorine-contaminated polyolefin waste to enable facile downstream processing. DE was first examined in the settings of PVC, PVC+HDPE, PVC+LDPE, and PVC+PP. Consistent NH₄Cl yields of ~100% suggest HDPE, LDPE, and PP had no influence on PVC dechlorination (FIG. 24). Meanwhile, ATR-FTIR showed that post-reaction polyolefins retained their original structure, although their molecular weights decreased. These results together implied that PVC and polyolefins are mutually non-interfering during the reaction.

Using a simulated chlorine-contaminated polyolefin waste stream composed of LDPE, HDPE, PP, and PVC, chlorine-free polyolefins, soluble dPVC, and NH₄Cl crystals (isolated yield of 94.4%) were obtained with ease of separation (FIG. 25). Comparable results were also achieved using PVC and polyolefin commodities.

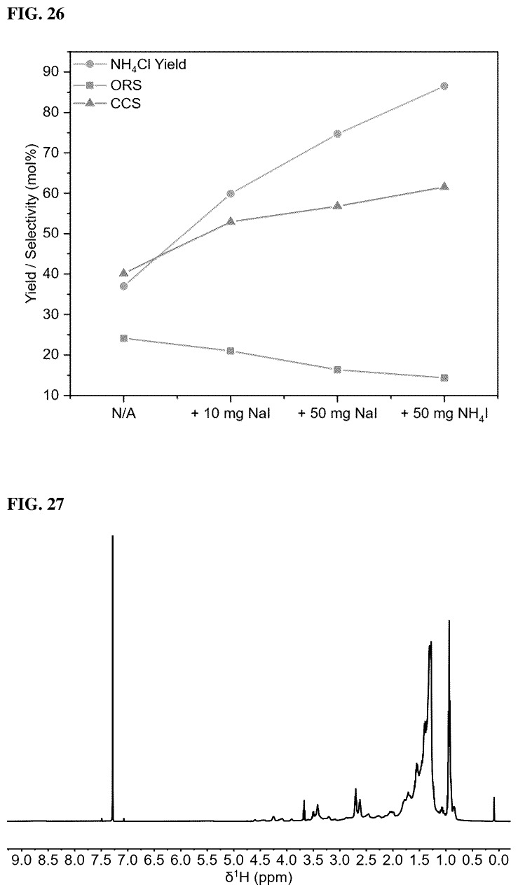

The addition of catalytic amounts of sodium iodide (NaI) or ammonium iodide (NH₄I) during PVC dechlorination resulted in increased EOD, decreased ORS, and increased CCS (FIG. 26). This substantial increase in the dechlorination rate was attributed to the iodide-enhanced elimination over ether substitution pathways, as reflected in the ether and C═C selectivity trends with the addition of iodides.

In Situ Hydrogenation of dPVC

In this example, it is demonstrated that the process can be easily adjusted to produce valuable products ranging from fuel detergent additives to lubricants/waxes from PVC waste in one step with the concept of in situ hydrogenation. More specifically, hydrogenation catalysts such as 5 wt % platinum on carbon (Pt/C) were added and the new NH₃ filling setup (FIG. 16A) was used to fill a certain amount of H₂ to the reactor after filling with NH₃. The hydrogenation catalysts applicable to this reaction include but are not limited to Pt/C, ruthenium on carbon (Ru/C), nickel on carbon (Ni/C), palladium on carbon (Pd/C), rhodium on carbon (Rh/C), iridium on carbon (Ir/C), silver on carbon (Ag/C), gold on carbon (Au/C), and copper on carbon (Cu/C) with different metal loadings. Different supports include C, silica (SiO₂), alumina (Al₂O₃), zirconia (ZrO₂), ceria (CeO₂), titania (TiO₂), and more. Supported alloy catalysts include but are not limited to PtNi/SiO₂, PtCo/SiO₂, PtSn/SiO₂, PtAu/SiO₂, PdNi/SiO₂, and PdAg/SiO₂ with different metal loadings. With 5 wt % Pt/C as an example, it was demonstrated that a colorless viscous liquid product can be produced. Compared to the case without in situ hydrogenation, this hydrogenated dPVC product possesses a much cleaner ¹H NMR spectrum without peaks corresponding to C═C (FIG. 27). As seen in FIG. 27, this hydrogenated dPVC product has dominantly-CH₂-groups in the structure.

Compared to the case without H₂ and 5 wt % Pt/C, the addition of H₂ and Pt/C renders a much lower ORY/ORS and a relatively lower NY/NS with similar NH₄Cl yield (Table 2). This indicates that in situ hydrogenation shifts the dechlorination pathways towards dehydrochlorination followed by hydrogenation, resulting in a hydrogenated dPVC product with lower consumption of alcohol and NH₃. The existence of nitrogen and oxygen content in this hydrogenated dPVC product allows it to serve as a potential fuel detergent additive, given that nitrogen and oxygen content is commonly seen in fuel detergent additives, such as polyetheramine and polyisobutylene succinimide.

TABLE 2
Comparison of the cases with and without H₂ and 5 wt
% Pt/C. Reaction conditions: PVC powders, 221 mg; 1-butanol,
5 mL; NH₃, 12.7 mmol; temperature, 150 °C for 18
h. The values for ORY, ORS, NY, and NS reported in this
table were determined from elemental analysis.

| | NH₄Cl | | | | |
|---|---|---|---|---|---|
| | Yield | ORY | ORS | NY | NS |
| Entry | (mol %) | (mol %) | (mol %) | (mol %) | (mol %) |
| w/o 4.2 mmol H₂ | 87.8 | 10.8 | 12.6 | 14.2 | 16.5 |
| and 59 mg 5 wt % | | | | | |
| Pt/C | | | | | |
| w/4.2 mmol H₂ and | 89.9 | 4.4 | 4.7 | 10.7 | 11.6 |
| 59 mg 5 wt % Pt/C | | | | | |

Similar to the case without H₂ and 5 wt % Pt/C, near complete dechlorination can be achieved at 170 °C for 18 h as well with in situ hydrogenation. Varying the NH₃ loading, H₂ loading, and types of alcohols can tune the composition of different functional groups in the hydrogenated dPVC product. For instance, 2-butanol can reduce the ORY and ORS to as low as 2 mol %. The observation of no char when using 2-butanol with the addition of H₂ and 5 wt % Pt/C suggests that in situ hydrogenation can stabilize the chain and suppress char formation. This additional handle of dPVC chain stabilization enabled the use of other solvents such as THF to tune the N/O content in the hydrogenated dPVC product, allowing for the formation of various products ranging from fuel detergent additives to lubricants/waxes.

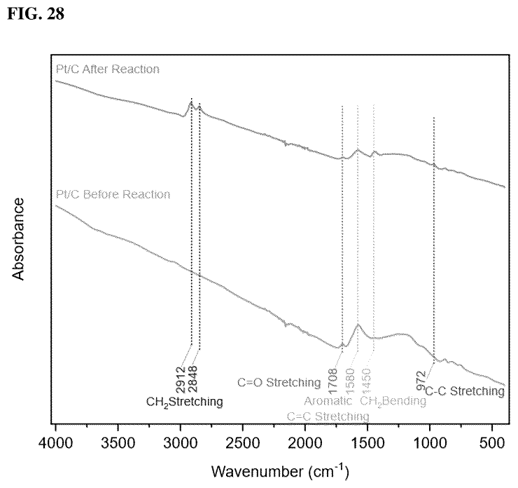

By varying the catalyst loadings, it was also demonstrated that a PE-like insoluble dPVC product can be formed (FIG. 28), which can be separated out from the post-reaction catalysts through hot filtration. This reflects that the carbon products from in situ hydrogenation, existing in both insoluble and soluble portions, can be fully valorized. Additionally, adjusting catalyst loadings can tune the ratios of insoluble and soluble portions, enabling facile production of different valuable products based on demands.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of making a dechlorinated polymer, comprising the steps of:
contacting a chlorinated polymer with an alcohol and ammonia, thereby forming a mixture; and
heating the mixture to about 125 °C to about 250 °C;
thereby producing the dechlorinated polymer and a chloride.

2. The method of claim 1, wherein the chlorinated polymer is polyvinyl chloride; and the dechlorinated polymer is polyvinyl.

3. The method of claim 1, wherein the chloride is ammonium chloride.

4. The method of claim 1, wherein the chloride is not hydrochloride.

5. The method of claim 1, wherein the method does not produce hydrogen chloride gas.

6. The method of claim 1, wherein the mixture is heated to about 150 °C to about 200 °C.

7.-9. (canceled)

10. The method of claim 1, wherein the alcohol is an aliphatic alcohol.

11. The method of claim 1, wherein the alcohol is a primary alcohol or a secondary alcohol.

12. (canceled)

13. The method of claim 1, wherein the alcohol is selected from the group consisting of 1-propanol, 1-butanol, 1-pentanol, 1-hexanol, 1-heptanol, and 2-butanol.

14. The method of claim 13, wherein the alcohol is 1-butanol.

15. The method of claim 1, further comprising an ethereal solvent; wherein the alcohol is admixed with the ethereal solvent.

16. The method of claim 1, further comprising the step of contacting the mixture with ice after heating the mixture.

17. The method of claim 1, wherein contacting the chlorinated polymer with the alcohol and the ammonia comprises contacting the mixture with ammonia at a psig of about 60 to about 300 psig.

18-28. (canceled)

29. The method of claim 1, wherein contacting the chlorinated polymer with an alcohol and ammonia further comprises contacting the mixture with a polyolefin.

30. (canceled)

31. The method of claim 1, further comprising contacting the mixture with an iodide catalyst.

32. The method of claim 31, wherein the iodide catalyst is selected from the group consisting of sodium iodide (NaI) and ammonium iodide (NH₄I).

33. The method of claim 31, wherein the iodide catalyst is present in an amount of about 0.1 mol % to about 10 mol % relative to the chlorinated polymer.

34.-61. (canceled)

62. The method of claim 1, wherein the method is performed in the absence of an alkali metal hydroxide.

63. A polymer produced by the method of claim 1.

64. (canceled)

65. The method of claim 1, wherein the alcohol is a primary alcohol.
